(19) United States
(12) Patent Application Publication
(10) Pub. No.: US 2011/0163740 A1
(43) Pub. Date: Jul. 7, 2011

(54) BLANKET PROBE

(75) Inventors: David Edward Russell, Sherwood Park (CA); Hoan Van Nguyen, Edmonton (CA); Yuwu Yu, Edmonton (CA); Edwin Walter Reid, St. Albert (CA)

(73) Assignee: RUSSELL NDE SYSTEMS INC., Edmonton (CA)

(21) Appl. No.: 12/986,084

(22) Filed: Jan. 6, 2011

Related U.S. Application Data
(60) Provisional application No. 61/292,651, filed on Jan. 6, 2010.

(51) Int. Cl. G01B 7/06; G01N 27/82; G01N 27/72

(52) U.S. Cl. 324/220; 324/229; 324/228

(57) ABSTRACT

A blanket probe for detecting the thickness of a wall having a non-planar surface has a probe portion comprising a planar substrate that is flexible in one or two dimensions, an array of detectors mounted on the substrate and at least one interface for communicating signals to and from each detector.

### FIELD

This relates to a blanket probe for non-destructive inspection of metals such as carbon steel, copper, brass, cupro-nickel, ferritic and other alloys with a finite thickness.

### BACKGROUND

RFT (remote field testing), which may also be referred to as RFEC (remote field eddy current) and RFET (remote field electromagnetic technique), can be used to find defects in carbon steel, copper, brass, cupro-nickel, ferritic and other alloys with a finite thickness.

An example of a device that allows this is the Ferroscope 308, produced by Russell NDE Systems Inc. of Edmonton, Alberta, Canada (www.russelltech.com).

Using the Ferroscope 308, an RFT probe is moved down the inside of a pipe or tube and is able to detect inside and outside defects with approximately equal sensitivity.

Although RFT works in nonferromagnetic materials such as copper and brass, its sister technology eddy current is also suitable for these materials.

The basic RFT probe consists of an exciter coil (also known as a transmit or send coil) which sends a signal to the detector (or receive coil). Exciter coil 20 is energized with an

AC current and emits an alternating electro-magnetic field. The field travels outwards from exciter coil 20, through the pipe wall, and along pipe 12. The detector is placed inside pipe 12 two to three pipe diameters away from exciter 20 and detects the magnetic field that has travelled back in from the outside of the pipe wall (for a total of two through-wall transits).

In areas of metal loss, the field arrives at the detector with a faster travel time (greater phase) and greater signal strength (amplitude) due to the reduced path through the steel. Hence the dominant mechanism of RFT is through-transmission, and the dominant energy source is the axial magnetic field.

### SUMMARY

According to an aspect, there is provided a blanket probe for detecting the thickness of a wall having a non-planar surface. The blanket probe comprises a probe portion comprising a planar substrate that is flexible in one or two dimensions, an array of detectors mounted on the substrate and at least one interface for communicating signals to and from each detector.

According to other aspects, the substrate may be a flexible printed circuit board. The array of detectors may be a two dimensional array of detector coils. The array of detectors may be sensitive to an electromagnetic field having mutually orthogonal directions. The planar substrate may comprise one or more stiffeners to reduce flexibility in one dimension.

According to other aspects, the wall may be the wall of a pipe, tank or vessel. The wall may be made from at least one of carbon steel, copper, brass, cupro-nickel, and ferritic.

According to another aspect, one or more multiplexers may connect the array of detectors to the at least one interface to serially record a detection signal.

According to other aspects, there may be at least one exciter for exciting the wall. The at least one exciter may generate an electromagnetic field. The blanket probe may further comprise an operator unit for inputting instructions and displaying test results, an interface unit comprising the at least one interface for receiving detection signals from the detectors and sending control signals to the exciter unit, and an exciter unit for controlling the at least one exciter. The operator unit, the interface unit and the exciter unit may communicate by wired or wireless links. At least the operator unit and the interface unit may be housed within a portable housing.

According to other aspects, the wall may be a pipe wall and the at least one exciter is positioned on an opposite side of the pipe from the probe portion, inside the pipe, or adjacent to the probe portion.

According to another aspect, there is provided a method of testing a non-planar wall having a finite thickness, comprising the steps of: positioning a planar substrate that is flexible in one or two dimensions on the non-planar wall, the planar substrate having an array of detectors; exciting the non-planar wall; measuring detected signals generated by the array of detectors; and generating an output that characterizes the non-planar wall.

According to other aspects the planar substrate may be a flexible printed circuit board and the array of detectors may be a two dimensional array of detector coils. Measuring detected signals may comprise measuring mutually orthogonal components of an electromagnetic field. Measuring detected signals may comprise using multiplexers to serially record the detected signals. The non-planar wall may be made from at least one of carbon steel, copper, brass, cupro-nickel, and ferritic.

The method may further comprise the step of inputting instructions into an operator unit and transmitting the instructions to an interface unit, the interface unit measuring the detected signals and controlling an exciter that excites the non-planar wall.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic view of an exciter coil and blanket probe separated by 180° with respect the axis of the pipe, and with the axis of the exciter coil perpendicular to the axis of the pipe.

FIG. 2 is a schematic view of an exciter coil and blanket probe separated by 180° with respect the axis of the pipe, and with the axis of the exciter coil parallel to the axis of the pipe.

FIG. 3 is a schematic view of an exciter coil and blanket probe on the same side of the pipe, with the axis of the exciter coil perpendicular to the axis of the pipe.

FIG. 4 is a schematic view of an exciter coil and blanket probe on the same side of the pipe, with the axis of the exciter coil parallel to the axis of the pipe.

FIG. 5 is a schematic view of an exciter coil placed inside the pipe, with the axis of the exciter coil parallel to the axis of the pipe.

FIG. 6 is a schematic view of an exciter coil placed inside the pipe, with the axis of the exciter coil perpendicular to the axis of the pipe.

FIG. 7 is a schematic view of multiple exciter coils on the same side of the pipe as the blanket probe, with the axis of the exciter coils parallel to the axis of the pipe.

FIG. 8 is a schematic view of multiple exciter coils on the same side of the pipe as the blanket probe, with the axis of the exciter coils perpendicular to the axis of the pipe.

FIG. 9 is a schematic view of multiple exciter coils separated by 180° with respect the axis of the pipe from the blanket probe, and with the axis of the exciter coils parallel to the axis of the pipe.

FIG. 10 is a schematic view of multiple exciter coils separated by 180° with respect the axis of the pipe from the blanket probe, and with the axis of the exciter coils perpendicular to the axis of the pipe.

FIG. 11 is a schematic view of an instrument system for the blanket probe.

FIG. 12 is a schematic view of an array of detectors of the blanket probe.

FIG. 13 is a schematic view of an exciter unit.

FIG. 14 is a schematic view of an exciter box.

FIG. 15 is a block diagram of a blanket probe with detectors and multiplexers

FIG. 16 is a bottom plan view of a flexible circuit board used in a blanket probe.

FIG. 17 is a top plan view of the flexible circuit board of FIG. 16.

FIG. 18 is a top plan view of a blanket probe unit.

FIG. 19 is a side elevation view in section of the blanket probe unit of FIG. 18.

FIG. 20 is a schematic diagram of a column of detectors and a multiplexer in the blanket probe.

FIG. 21 is a top plan view of a multiplexer board.

FIG. 22 is a schematic view of an interface unit.

FIG. 23 is a schematic view of an operator's control unit.

FIG. 24 through 26 are examples of color maps used to identify outer defects, where closer spaced lines represent darker colors, which relate to a lower intensity detected magnetic field.

FIGS. 27 and 28 are examples of color maps used to identify internal defects, where closer spaced lines represent darker colors, which relate to larger detected phase changes.

FIG. 29 is a schematic view of a blanket probe used to detect differential phase measurements.

FIG. 30 is a graph showing the differential phase versus the axial distance on a pipe.

### DETAILED DESCRIPTION

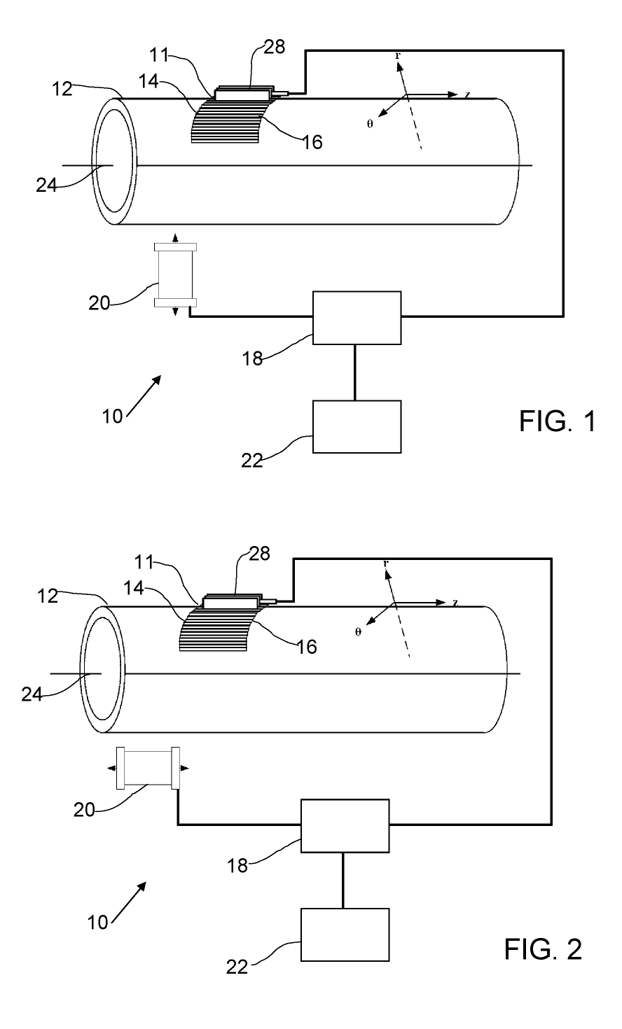

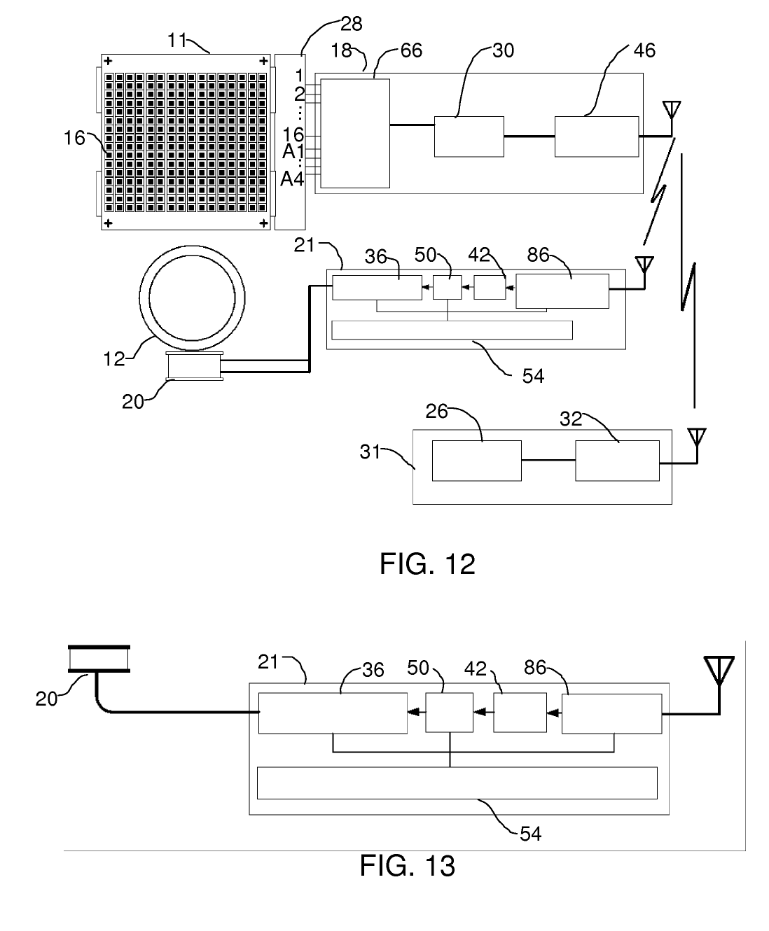

Referring to FIG. 1, there is shown a blanket probe 10 that is used to detect the thickness of a wall that has a non-planar surface, such as a pipe 12 as shown. Blanket probe 10 has a probe portion 11 comprising a planar substrate, such as a flexible printed circuit board 14, which is flexible in one or two dimensions. Referring to FIG. 12, an array of detectors 16 is mounted on substrate 14. Preferably, detectors 16 are in a two dimensional array, and are detector coils, although other types of detectors known in the art may also be used. Detectors 16 are connected to send and receive signals via an interface 18. As will be discussed, in a preferred embodiment, detectors 16 are sensitive to mutually orthogonal electromagnetic fields.

FIG. 1 through 10 show the various possible configurations that blanket probe 10 can be used to examine object 12. The actual configuration of blanket probe 10 will depend on the object being inspected, the preferences of the user, the type of equipment being used, and what is being looked for. Objects that may commonly be inspected include a pipe, pressure vessel or storage tank. Other suitable objects made may also be inspected that are made from suitable metals such as carbon steel, copper, brass, cupro-nickel, ferritic and other alloys with a finite thickness. The cross-section of the object may not necessarily be circular, but will generally be non-planar. A wired interface 18 between probe portion 11, exciter 20, and ferroscope 22 is shown, however blanket probe 10 will optionally have a wireless interface 18. The details of the interface will be explained below. Probe portion 11 is sensitive to magnetic fields in three mutually orthogonal directions shown by r (radial), θ (circumferential), and z (axial).

FIG. 1 shows a possible configuration where probe portion 11 is on one side of a pipe and exciter 20 is on the opposite. Exciter 20 can be opposite the centre of probe portion 11 or laterally displaced from probe portion 11 as shown. In this configuration the axis of exciter coil 20 is perpendicular to the axis 24 of pipe 12.

FIG. 2 shows a possible configuration where probe portion 11 is on one side of pipe 12 and exciter 20 is on the opposite. Exciter 20 is shown as being laterally displaced from probe portion 11. In this configuration the axis of exciter 20 is parallel to axis 24 of pipe 12.

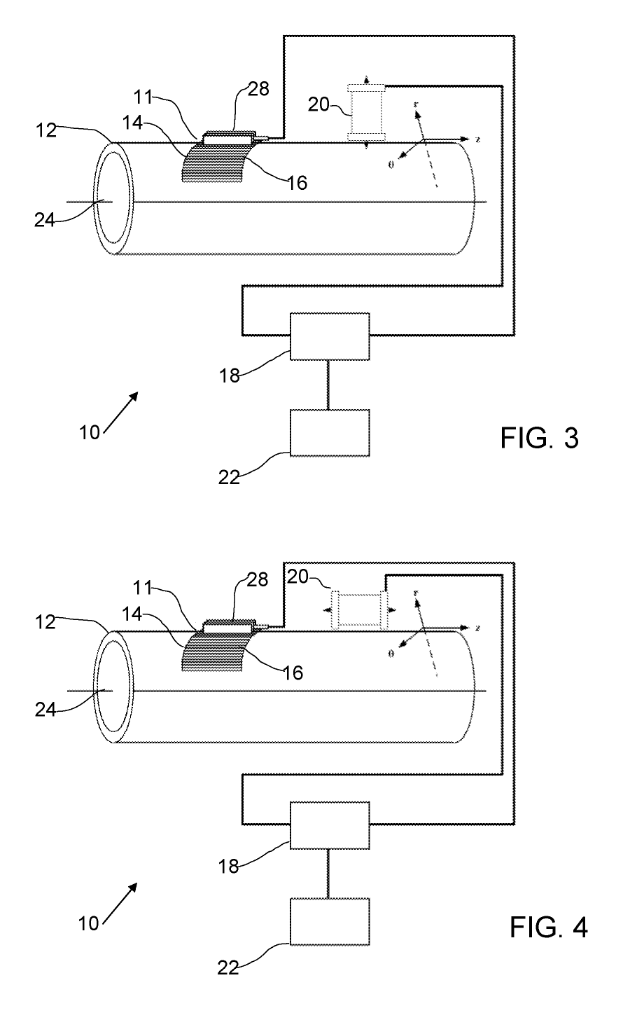

FIG. 3 shows a possible configuration where probe portion 11 and exciter coil are both on the same side of pipe 12. In this configuration the axis of exciter coil 20 is perpendicular to axis 24 of pipe 12.

FIG. 4 shows a possible configuration where probe portion 11 and exciter coil are both on the same side of pipe 12. In this configuration the axis of exciter coil 20 is parallel to axis 24 of pipe 12.

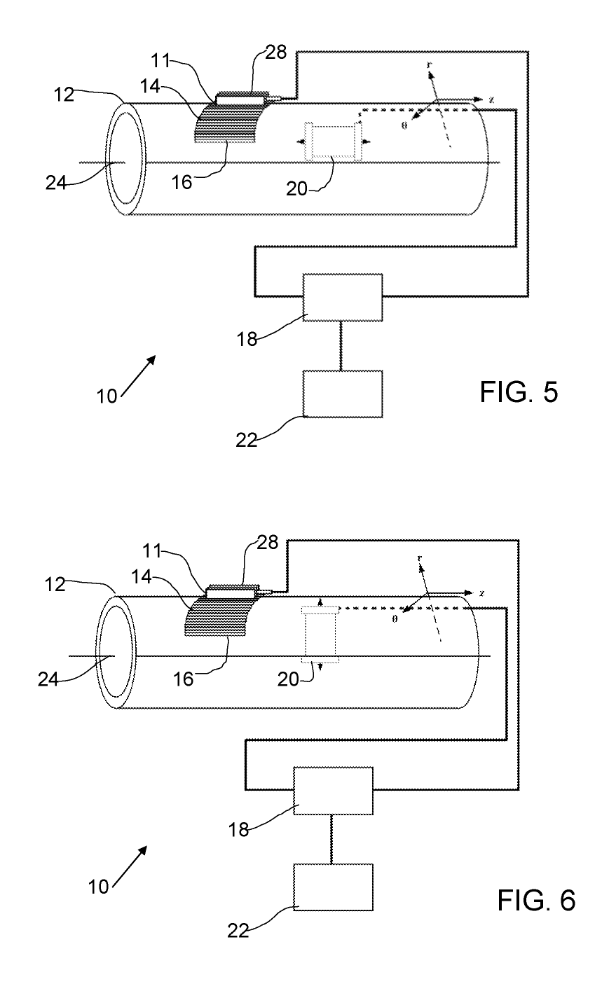

FIG. 5 shows a possible configuration where exciter 20 is inside of pipe 12. Exciter 20 can be laterally displaced from probe portion 11. In this configuration the axis of exciter coil 20 is parallel to axis 24 of pipe 12.

FIG. 6 shows a possible configuration where exciter 20 is inside of pipe 12. Exciter 20 can be laterally displaced from probe portion 11. In this configuration the axis of exciter coil 20 is perpendicular to axis 24 of pipe 12.

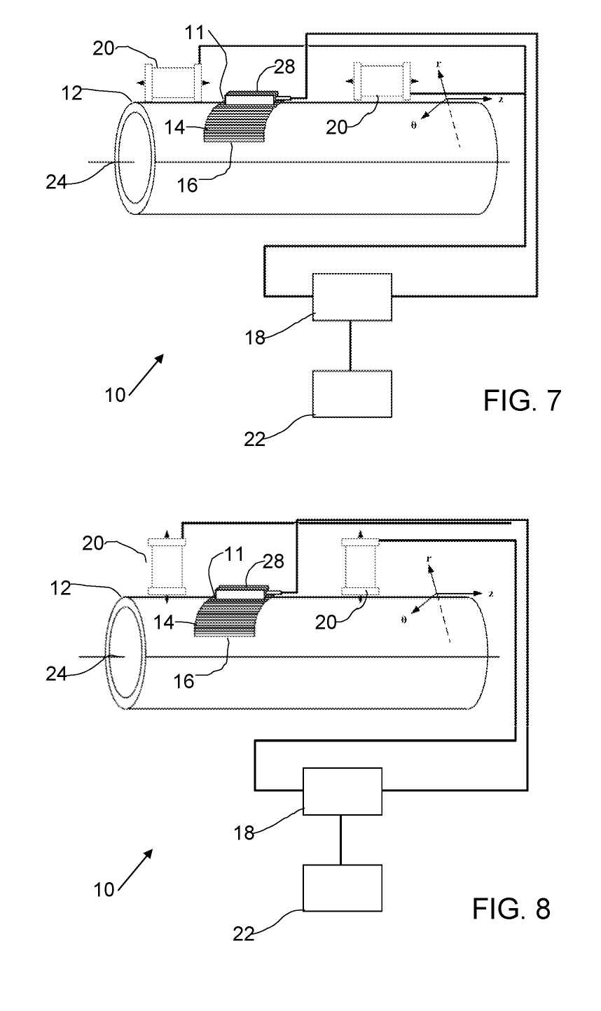

FIG. 7 shows a possible configuration where probe portion 11 and exciter coils are both on the same side of pipe 12. In this configuration there are multiple exciter coils 20 (two shown) where the axis of exciter coil 20s is parallel to axis 24 of pipe 12.

FIG. 8 shows a possible configuration where probe portion 11 and exciter coils 20 are both on the same side of pipe 12. In this configuration there are multiple exciter coils (two shown) where the axis of exciter coil 20 is perpendicular to axis 24 of pipe 12.

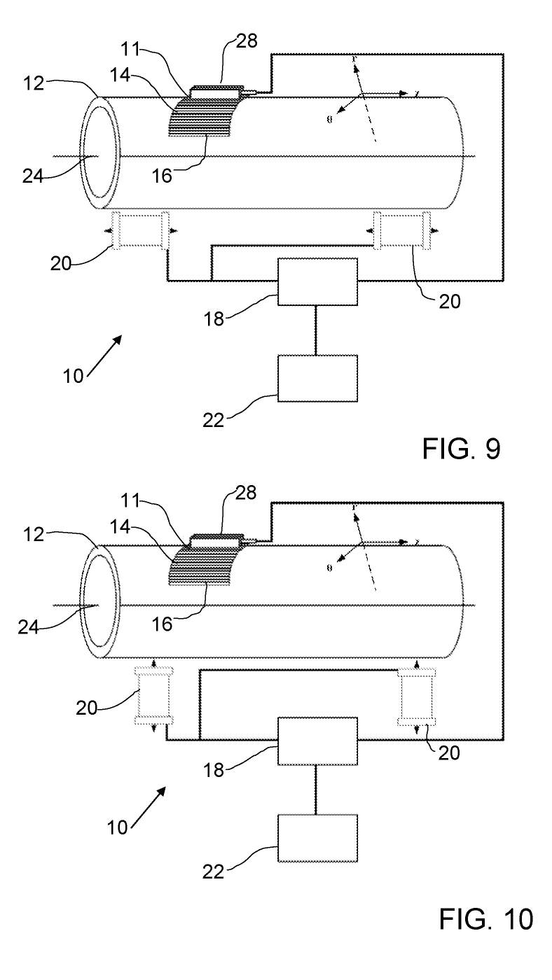

FIG. 9 shows a possible configuration where probe portion 11 is on one side of a pipe and multiple exciter coils 20 (two shown) are on the other side. In this configuration the axis of exciter coils is parallel to axis 24 of pipe 12.

FIG. 10 shows a possible configuration where probe portion 11 is on one side of a pipe and multiple exciter coils 20 (two shown) are on the other side. In this configuration the axis of exciter coils is perpendicular to axis 24 of pipe 12.

Blanket Probe Design—There will now be described a preferred embodiment of blanket probe 10. Once the principles of operation are understood, it will be understood that modifications to this embodiment, such as the arrangement of components, type of components, methods of acquiring data transmitting signals, etc. may be made while providing the same functions

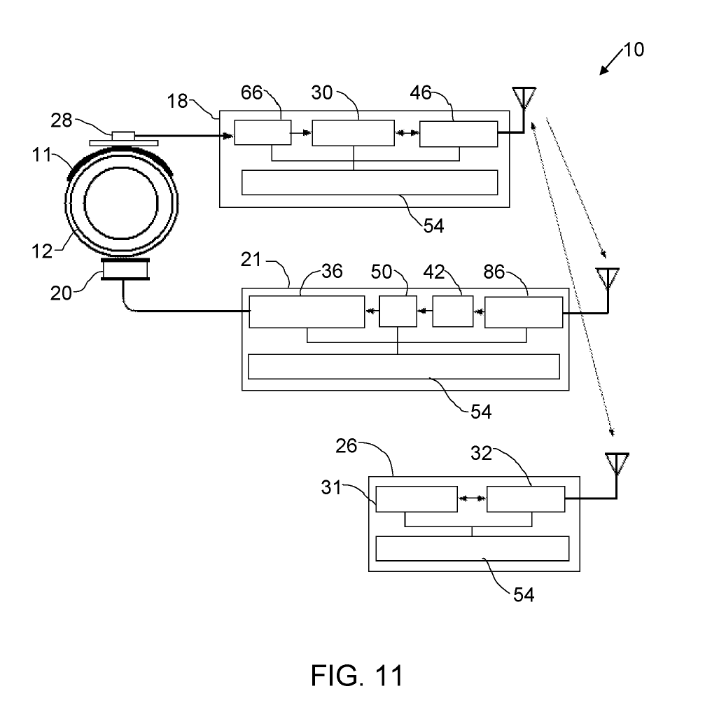

Referring to FIG. 11, a functional block diagram of the major elements of blanket probe 10 is shown as a system of instrumentation with a probe portion 11, interface 18, exciter unit 21, and operator control & recorder unit 26. Referring to FIG. 12, probe portion 11 ,contains a rectangular array of 256 magneto-impedance detectors 16 and sixteen 16-channel analog multiplexers 28, which are used as line concentrators. The object being tested is an insulated pipe 12.

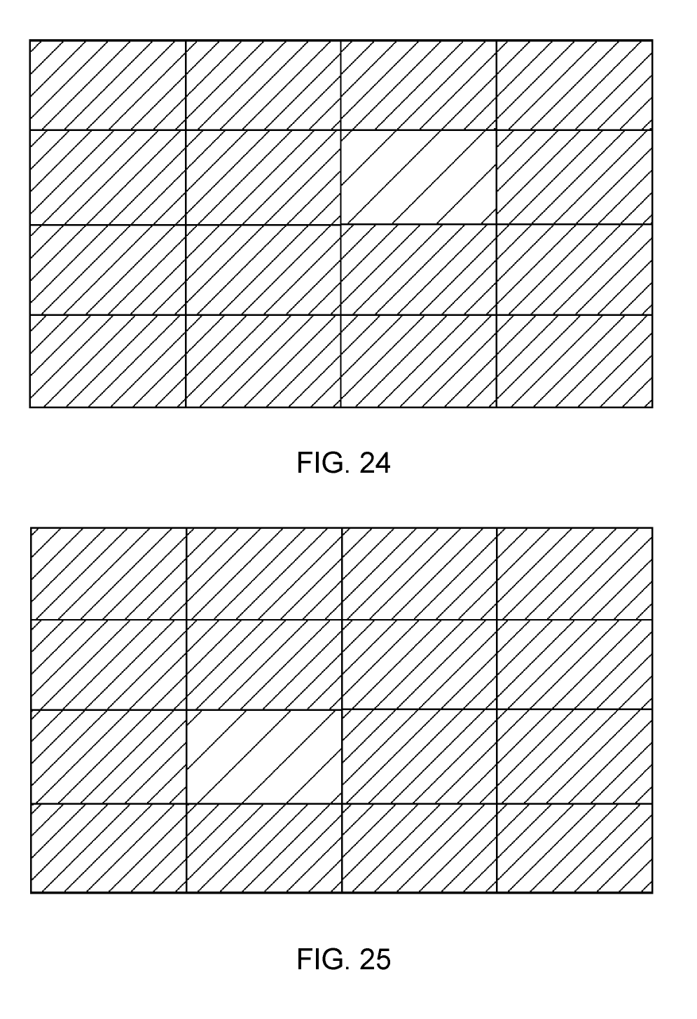

The operator selects parameters from a software driven menu on a portable computer as part of operator control block 26 to set up test conditions and execute test instances. The operator's computer 31 (shown in FIG. 24), called the client, displays measurement data presenting the progress of tests in real time, which is displayed on a two-dimensional color map. Computer 31 also logs test instances placing their record on a mass storage media (e.g., memory stick).

Interface Unit—The interface unit 18 preferably provides a two-way wireless access between the operator's computer 31 (client—shown in FIG. 24) and probe portion 11 where command information and measurement data are exchanged. Interface 18 may also provide a wired connection. The interface unit 18 also preferably provides the excitation signal for a remote exciter unit 20 through a wireless link. The purpose for this arrangement is to supply an excitation signal while at the same time also provide a synchronous reference signal to the lock-in analyzer, a function that is performed by the server computer 30, which is part of the interface unit 18.

The exciter transceiver 86 is permanently in the receive mode to receive the excitation signal, the digital signal processor 34 transforms the excitation signal, which may be in the form of pulses into a sine wave, and the power amplifier 36 supplies the necessary current to drive exciter coil 20, which provides the excitation magnetic field. FIG. 12 shows further details of probe portion 11. As shown, probe portion 11 has an array of 256 magneto-impedance detectors 16, although other array designs and different numbers of detectors 16 may also be used.

Exciter Unit—Exciter unit 21, which powers an exciter coil 20, consists of transceiver 86, digital signal processor 42, digital to analog converter 50 and audio frequency power amplifier 36. The purpose of exciter 20 is to set up an alternating magnetic field, whose flux which is conveyed through the ferromagnetic body of the object 12 being tested. This field is generated by passing a controlled amount of alternating current at one frequency or multiple frequencies through a solenoid coil placed adjacent to the wall of the object 12 being tested. For the case of a pipe, the axis of exciter coil 20 can be parallel or perpendicular to the axis of pipe 12. Exciter coil 20 is placed sufficiently far away from probe portion 11 to avoid direct coupling; only Through Transmission (“TT”) coupling conveyed by the ferromagnetic material of the object being tested is the desired arrangement. Two alternative exciter implementations are described next.

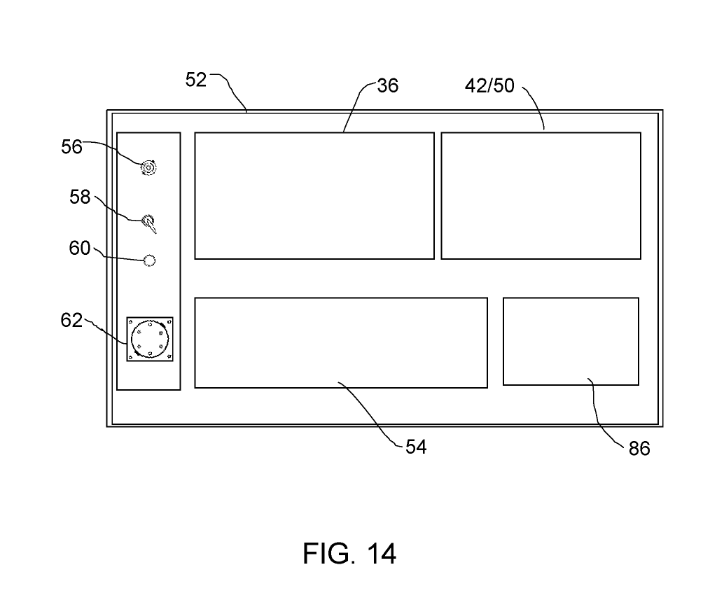

Referring to FIG. 13, a block diagram of an exciter unit 52 that drives exciter coil 20 is shown. The exciter current is supplied by an audio amplifier 36 that is driven by a digital signal processor 42, which receives a train of rectangular pulses with a frequency equal to the excitation frequency from the transceiver 86. The purpose of the digital signal processor 42 is to convert the rectangular pulses produced at the output of transceiver 86 into a sequence of binary coded words representing a sine wave. The digital to analog converter 50, in turn, produces an analog signal to drive the power amplifier 36 from the coded waveform. In this instance transceiver 86 permanently remains in the receive mode. Control of exciter 20 is exercised through the client computer 31 (shown in FIG. 24) which sets up the operational parameters in server computer 30. These features allow portability of this instrument, making it useful particularly in confined working conditions. A diagram of an exciter unit box 52 is shown in FIG. 14 with amplifier 36, transceiver 86, signal processor 42 and digital to analog converter 50, a battery 54, BNC connector 56 for an antenna, an on/off switch 58, a pilot light 60. Exciter coil 20 may be connected to box 52 using a connector 62, such as a four-pin 90° quick-twist Bendix™ or Lemo™ connector.

Probe Portion—Referring to FIG. 12, probe portion 11 is constructed from flexible printed circuit board 14, which contains an array of detectors 16. In this illustration, 256 magneto-impedance detectors 16 are arranged in a rectangular array. The electronic and mechanical design aspects of probe portion 11 are described below.

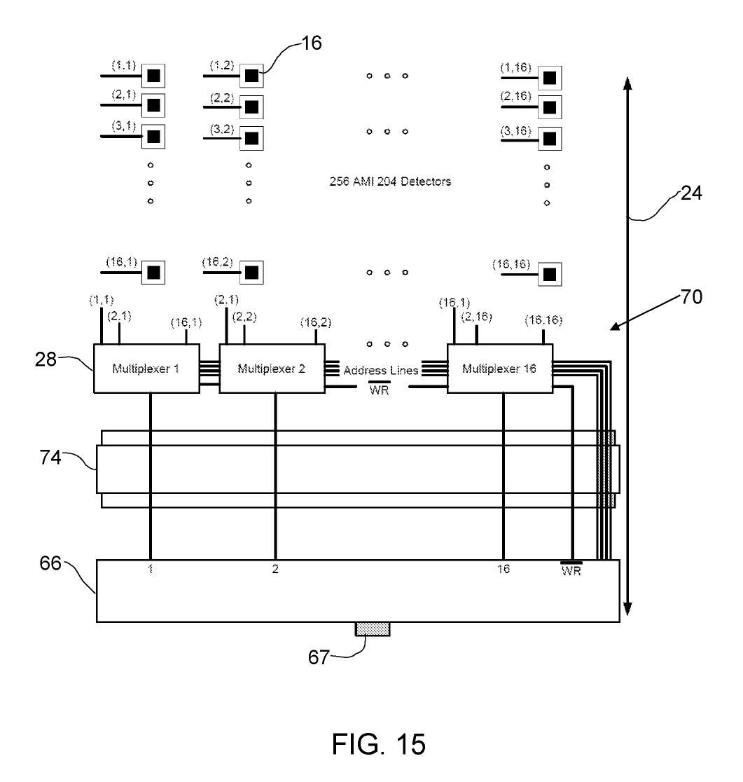

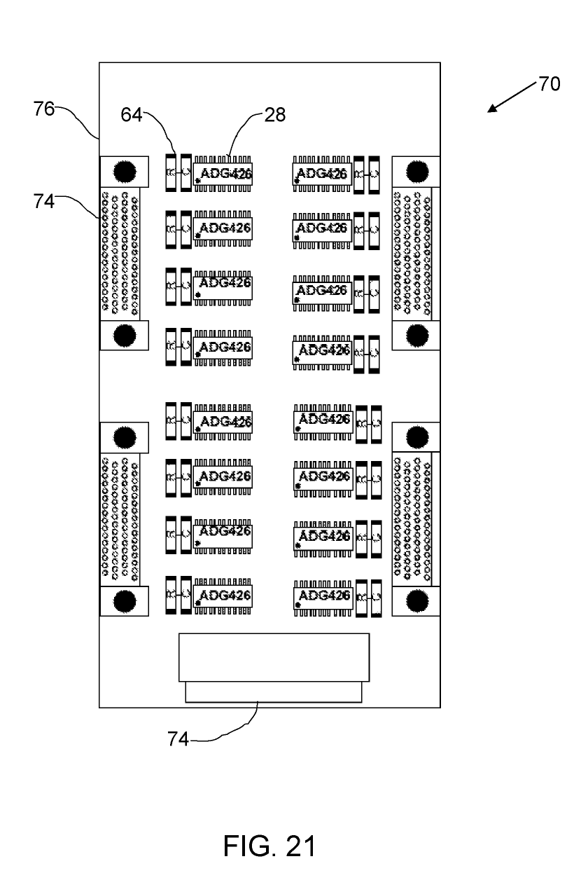

Electrical Design Aspects of Probe Portion—A block diagram in FIG. 15 shows the interconnection of magneto-impedance detectors 16, analog multiplexers 28, high-pass filters 64 (shown in FIG. 21), and a data acquisition system (DAS) 66. The USB output port 68 of DAS 66 is connected to server computer 30. The circuit is intended for use with coil or electronic magnetic field.

Referring to FIG. 15, a line concentrator 70 consisting of sixteen analog multiplexers (first-tier) 28 is used to sequentially connect signals from the 256 detectors 16 in groups of sixteen to a 16 channel data acquisition system (DAS) 66. Each multiplexer 28 is assigned to a row of sixteen detectors 16 and DAS 66 samples the detectors 16 along a column selected by first-tier multiplexer 28, which shares a common address bus. Analog multiplexers 1 to 16 comprise the first-tier multiplexer; the second-tier is the analog internal analog multiplexer (not shown) within data acquisition system 66. Columns containing 16 detectors are selected by the address lines on the first-tier analog multiplexers 28. The server computer 30 sequentially addresses columns starting from the column on the far left and incrementally advancing towards the far right. For each column selected, the internal analog multiplexer of data acquisition system 66 sequentially samples along the row of detectors 16 starting from the top row and incrementally advancing towards the bottom. The common of the selector switch of each analog multiplexer is connected to a corresponding channel of the data acquisition system 66.

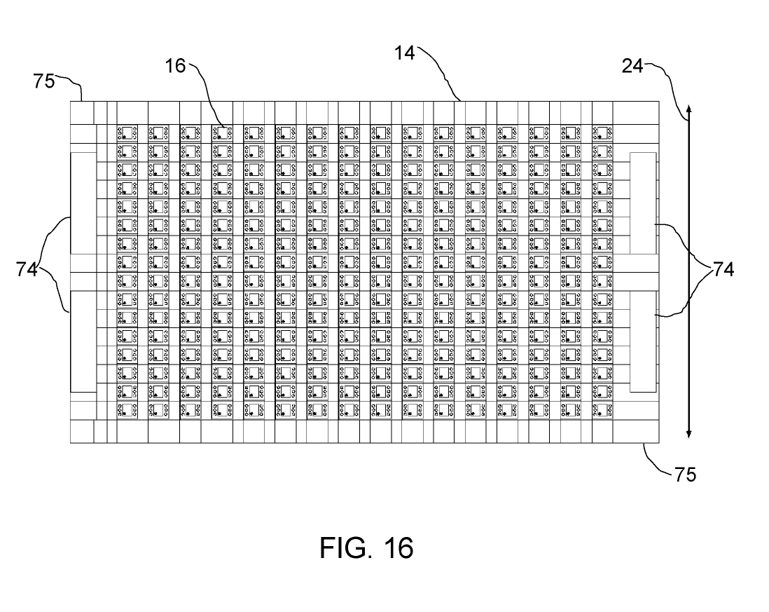

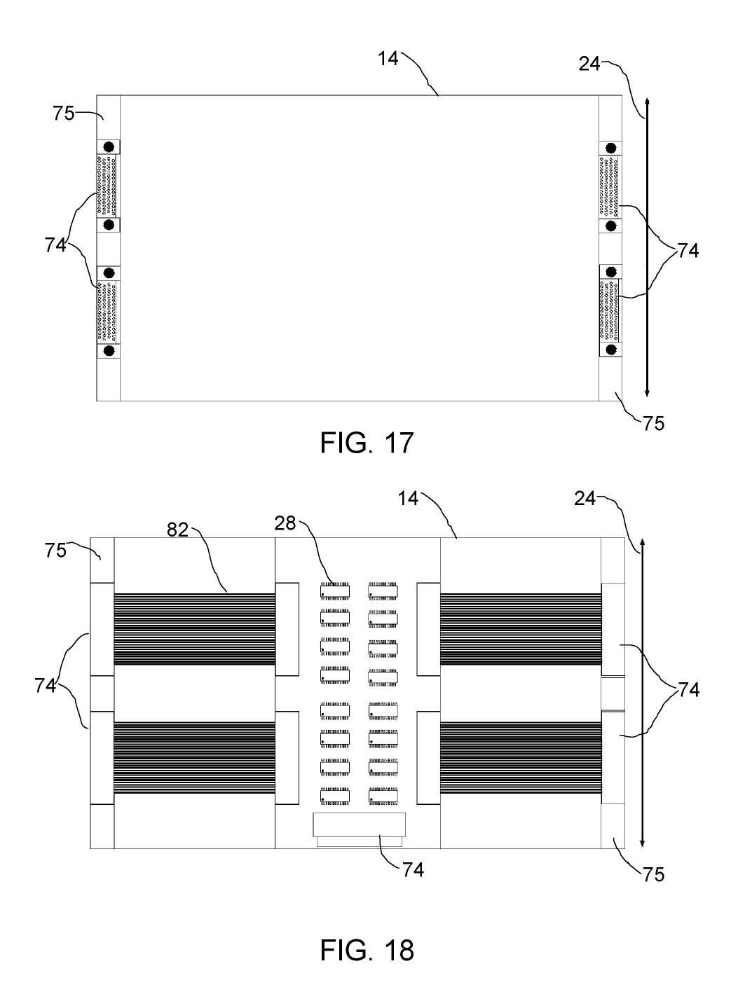

Mechanical Design Aspects of Probe Portion—Referring to FIG. 16, the side of the flexible circuit board 14 containing magneto-impedance detectors is intended to be placed in close proximity to the surface of the object being tested. The depicted example contains a square array of 256 detectors 16, where a conducting trace is drawn from each detector 16 towards one of the four 68-pin SCSI connectors 74. Detectors 16 may be AMI204 detectors available from Aichi Steel of Japan. Note that axis 24 of the pipe under test is in the vertical direction. FIG. 17 shows the top side of the flexible circuit board and showing the placement scheme for the 68-pin SCSI connectors 74.

Referring to FIG. 18, the complete probe portion 11 is shown. The upper flexible circuit board 16 contains sixteen analog multiplexers 28 and high-pass filters (HPF 64 shown in FIG. 21). Axis 24 of the pipe under test is in the vertical direction. The 68-pin SCSI connectors 74 at the bottom center makes connection to the data acquisition system 66. Flexible circuit board 14 may include stiffeners 75 on either end to only allow flexibility in one direction.

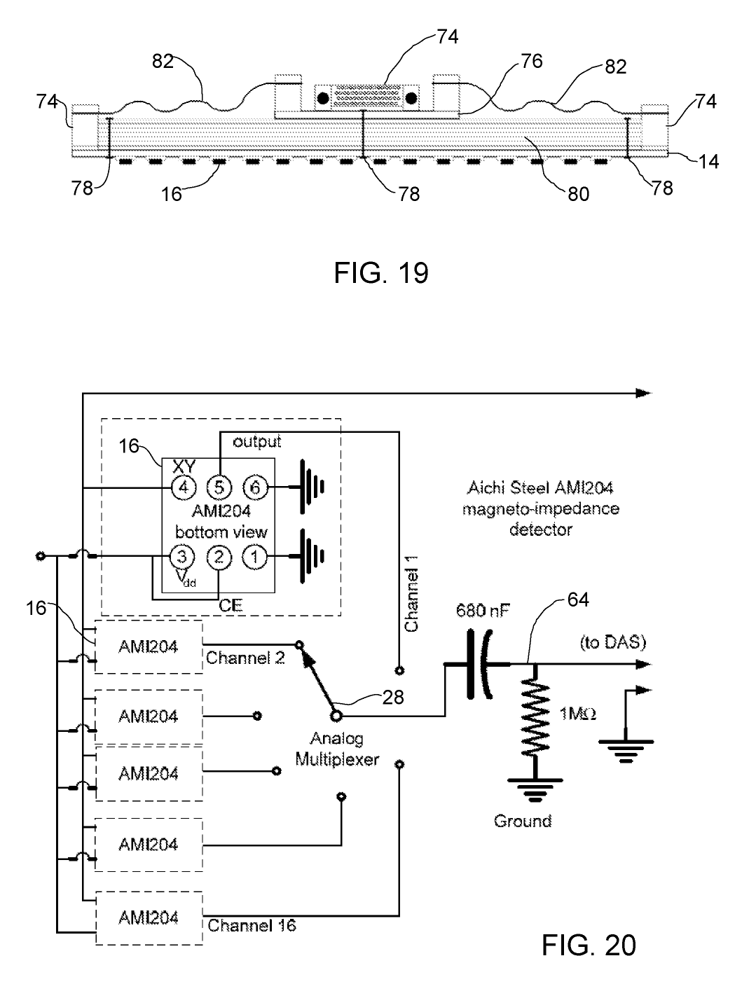

Referring to FIG. 19, in this configuration, a mezzanine board 76 is used to carry the analog multiplexers 28, as shown in FIG. 21. Board 76 is rigid, is mounted above the detector board 14 and is secured by pins 78 at the top and bottom center of board 76, which pass through a stack of mylar sheets 80 where they attach to detector board 16.

Mylar sheets 80 are used to form a laminate which separates detector board 14 from mezzanine board 76. This arrangement allows detector board 14 to bend around the outer surface of a pipe 12, as shown in FIG. 11. Flexible board 14 contains 256 magneto-impedance type detectors 16 as shown in FIG. 16. Referring to FIG. 21, rigid circuit board 76 contains sixteen 16-channel analog multiplexers (first tier) 28 and sixteen high-pass filters 64.

Detectors—Suitable results have been obtained by using Aichi Steel's AMI204 two-axis magneto-impedance detectors. In pipe examination applications, these detectors are capable of measuring the magnetic field along an axis parallel to pipe 12 and around its circumference. Other benefits making this type of detector a good choice include: AMI 204's are ˜100 times more sensitive than coil type detectors, and probe portion 11 affords higher density array than could be formed with coil type detectors. The AMI204 is a two-axis magneto-impedance detector capable of measuring magnetic fields in two mutually orthogonal directions, both of which are parallel to the planar surface of the device's package.

The AMI204 magneto impedance detector may be used in a ball grid array (BGA) package, which is mounted on a DIP carrier. The AMI204 detector is available in a surface mount package, which contains two detector units (one for each direction). Each detector contains two magneto-impedance detectors wound with amorphous magnetic wire, a pulse generator, logic control circuit, and an instrumentation amplifier. The frequency range of the measured magnetic field can vary over the range from a static field to an alternating field up to 1 kHz.

First-Tier Multiplexer—Referring to FIG. 20, as mentioned above, multiplexers 28 are used to perform the switching so that the 256 analog signals from AMI 204 detectors can be, applied to data acquisition system 66 in groups of 16 channels at a time. This function is accomplished by first-tier analog multiplexers 28. Each multiplexer 28 is designated to a given column containing sixteen detectors 16, and all multiplexers 28 sample a selected row of detectors in unison. The data acquisition system 66 has its internal sixteen channel multiplexer, which forms the second tier where voltages across a given row of detectors are selected. FIG. 20 shows a conceptual schematic diagram for a column containing sixteen AMI204 detectors 16 and an analog multiplexer 28. Probe portion 11 has sixteen of these columns of detectors 16.

FIG. 21 shows a drawing of the line concentrator 70 with first-tier multiplexers 28. The depicted multiplexers 28 may be Analog Devices ADG426 in the SSOP surface mount package. A high-pass filter 64 accompanies each multiplexer 28, which is used as a DC block.

The 68-pin SCSI receptacles 74 on the left and right are interconnected with short pieces of ribbon cable 82 (of equal length) to flexible circuit board 14. The SCSI receptacle 74 on the bottom center is used for making connection to data acquisition system 66.

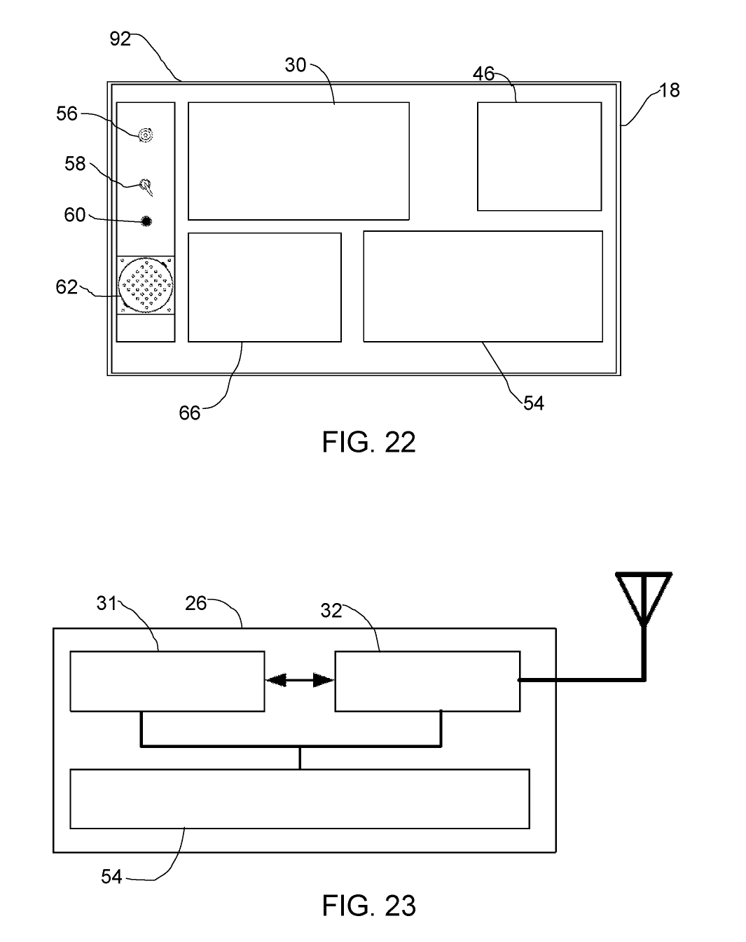

Interface Unit—Referring to FIG. 22, a conceptual drawing of the physical layout of interface unit 18 in a box 92 is shown. Interface unit 18 manages the traffic of data and control signals to/from operator's computer 31 (shown in FIG. 24). It also generates the excitation signal which is also the phase reference for the lock-in detector. The excitation signal is sent wirelessly to exciter 20 by the interface unit transceiver 46 to the exciter transceiver 86. Interface unit 18 is comprised of a data acquisition system 66, an interface unit transceiver 46, server computer 30, and battery 54.

The entire blanket probe instrument 10, with exception of exciter 20, can be packaged in an aluminum instrument case 92, for example, with the lid (not shown) of case 92 containing probe portion 11 and its cable. It may also be possible to use the lid of the case to contain exciter 20. Each item is firmly secured in place within well fitted foam compartments. Blanket probe 10 is preferably operated with the items left in place. A panel provides the on/off switch 58, pilot light 60, a multi-pin Bendix™ quick connector 62, and a BNC connector 56 for antenna or cable. The following sub-sections contain a brief description of components within the interface unit.

Transceiver 46 may be an ACCES™ WM-09-232-020 radio modem which operates at 9600 baud. It is connected to one of the I/O ports of the server computer 30 using a RS-232 nine pin connector (not shown), and operates in the half-duplex mode. The purpose of transceiver 46 is to provide a remote means of executing tests and receiving measurement data. The transmitter section of the interface unit's transceiver 46 serves two functions in separate time intervals: (1) provides a wireless link to exciter 20, and (2) returns measurement data to the client computer at the operator's position.

The data acquisition system 66 may be an ACCES model USB-AI16-16A data acquisition system which contains a 16 channel analog multiplexer (second-tier), 16-bit analog-to-digital converter, and serial interface using a USB port 67 (shown in FIG. 15).

Server 30 is a compact computer which responds to the invigilation of a test run. It sets up the DAS operational parameters, records measurement data, performs data reduction, and transmits processed data via a radio modem to the client computer. There are two important tasks performed by server; these are: respond to the operator's test condition selections; and provide digital signal processing functionality (lock-in analyzer) to reduces the bulk of measurement data that needs to be transmitted to the client computer for display and logging.

Server 30 is programmed to automatically load set-up test parameters in the data acquisition system, and begin to sequentially scan through all columns using first-tier multiplexers 28 and channels (rows of detectors) using the second-tier multiplexer which is an internal component of the data acquisition system 66. For each row position selected by first-tier multiplexers 28, data acquisition system 66 records the voltage measurement across the sixteen columns of detectors 16 for a given row position and writes the corresponding data to a unique text file. When the test routine has completed, there will be 16 text files.

A Matlab™ program may then be used to automatically read the 16 text files and apply a digital signal processing algorithm to compute the magnitude and phase values for all of the detector positions. This information is stored in a separate text file, which is later transmitted from server 30 to the client computer over a pair of radio modems. The client receives the processed data and displays results using a two-dimensional color graphic display revealing defect location.

Battery 90 is preferably designed with inverters to efficiently provide the required operating voltages for the analog multiplexers, instrumentation amplifiers, analog-to-digital converter, micro-controller, modulator (transmitter), and de-modulator (command receiver). It is recommended that rechargeable batteries such as Li-ion or gel-cells be used.

Operator's Computer and Radio Modem—Referring to FIG. 24, a block diagram of the client computer 31 and transceiver 32, such as a radio modem, is shown. Test instances are invigilated by the operator for the client computer 31. A data packet containing the frequency of the oscillator, and number of complete cycles that will be recorded, is preferably transmitted to server computer 30 between transceivers 32 and 46.

The operator exercises control of the instrument and displays measurement data using a portable (lap-top) computer 31. A modern computer running for example WindowsXP™ or LINUX™ is preferably. Lab View (or equivalent) may be used to generate control data and record measurement data. A kernel of MATLAB™ could be installed to perform digital signal processing, statistical analysis, and to display graphics. This would allow curve fitting and data interpolation for high quality graphics. The computer communicates directly to the interface box through a USB port.

Results—There will now be described some results that were obtained using the embodiment described above.

Amplitude Measurements—The first part of our research was to determine whether only amplitude measurements would be sufficient to determine the location and severity of defects. A 6″ steel pipe was machined with a 16 mm diameter milling tool to model external defects. Pipe 12 also had internal defects; these were machined with a 26 mm diameter mill to model 35%, 40%, and 75% pitting-type wall loss.

Exciter coil 20 was placed opposite probe portion 11 as shown in FIG. 1. Note that the axis of the coil is perpendicular to axis 24 of pipe 12. A voltage was induced on each detector coil of probe portion 11, which was proportional to the intensity of the normal component of the magnetic field on the surface of pipe 12. To equalize the effect of having a non-uniform magnetic field distributed over the circumference of pipe 12, the instrument was first calibrated on a known-good-pipe.

A calibration process, written in Matlab™, was used to obtain weighting factors that are used to compensate for the voltage variations among the detector coils. In our experiment we recorded five complete cycles of voltage waveform on each coil and computed their root-mean-square (r.m.s.) values. The r.m.s. value of the voltage on each detector coil was computed by Matlab™ and displayed on a two-dimensional display using a color map to show the field intensity versus coil position.

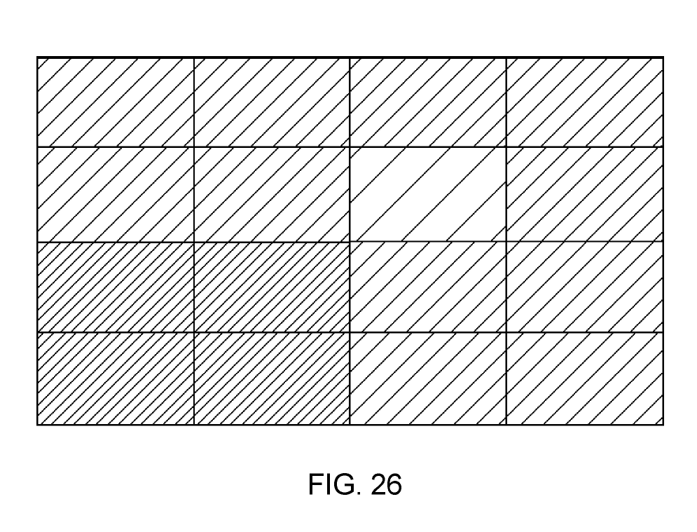

FIG. 24 through 26 show examples of the color map used to identify the location of 35%, 40%, and 75% outer defects, respectively. The darkness of the color is represented by the spacing of the lines. For example, a darker color shows a lower intensity of magnetic field in comparison to a bright color. Probe portion 11 was moved to different locations to check the sensitivity of various detector coils. FIG. 24 depicts the results of an amplitude measurement of the 35% outer defect, where the defect appears in the third column, second row. FIG. 25 depicts the results of an amplitude measurement of the 40% outer defect, where the defect appears in the second column, third row. FIG. 26 depicts the results of an amplitude measurement of the 75% outer defect, where the defect appears is in the third column, second row.

Outer defects were easily detected using an amplitude measurement method with blanket probe 10, however, it was found that internal defects were difficult to recognize. That is because external defects have an amplitude variation of 15% to 25% whereas for internal defects, the variation is an order of magnitude smaller. The phase measurement method is therefore preferably, as it is far more sensitive for locating internal defects.

Phase Measurement—An important aspect of our design is to develop a simple and reliable phase measurement technique that could detect internal defects. Phase information was obtained from the Fourier coefficient of the fundamental component of the measured signal, which is compared to the phase of the voltage signal of the other detectors.

Exciter coil 20 was placed on one side of a steel pipe with probe portion 11 placed on the opposite side. It was experimentally determined that exciter coil 20 could be offset by as much as ˜23 cm from the center of probe portion 11. In that way exciter coil 20 was at a distance sufficiently removed from probe portion 11 to avoid interference caused by the returning lines of magnetic flux. The axis of the coil was perpendicular to axis 24 of pipe 12.

A calibration was performed on known-good-pipe to determine the phase relationships of every detector within the array with respect to the reference detector.

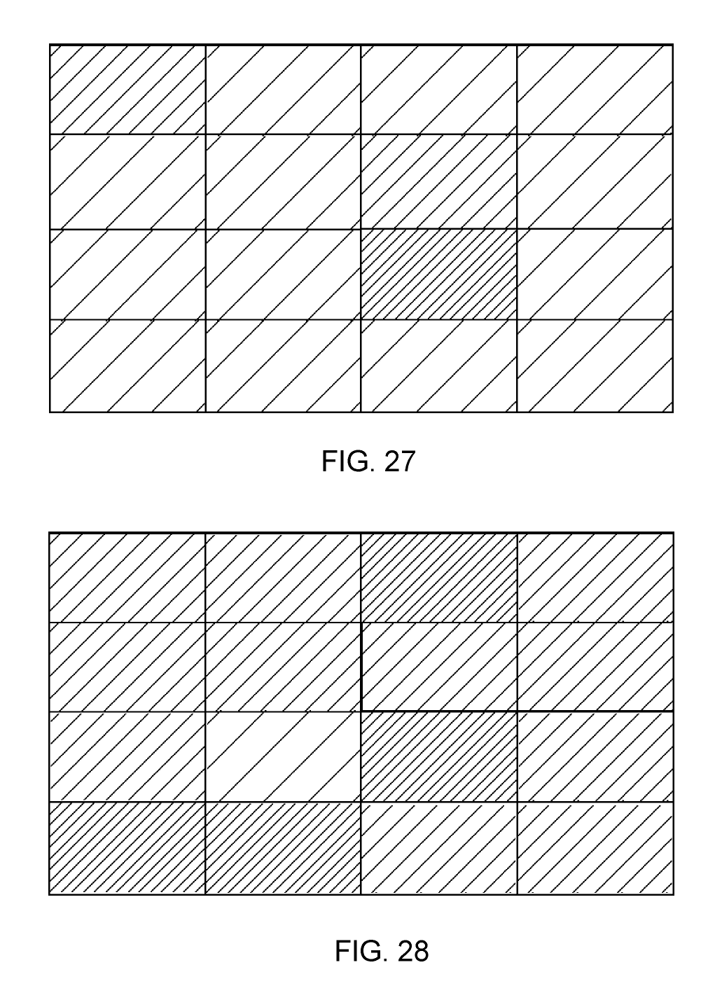

FIGS. 27 and 28 show examples of a color map used to identify the location of 50% and 70% internal defects, respectively. Dark colored spots (represented by closer spacing of lines) shows large phase change associated with a perturbation of magnetic field in the region of an internal defect. FIG. 27 relates to a 50% inner defect with a 16 mm diameter. the defect appears in the third column and second row. However, in FIG. 28, which relates to a 70% inner defect there is ambiguity as to the location of the defect, and we can only conclude that it appears somewhere in the third column. To improve sensitivity, differential phase measurements may used.

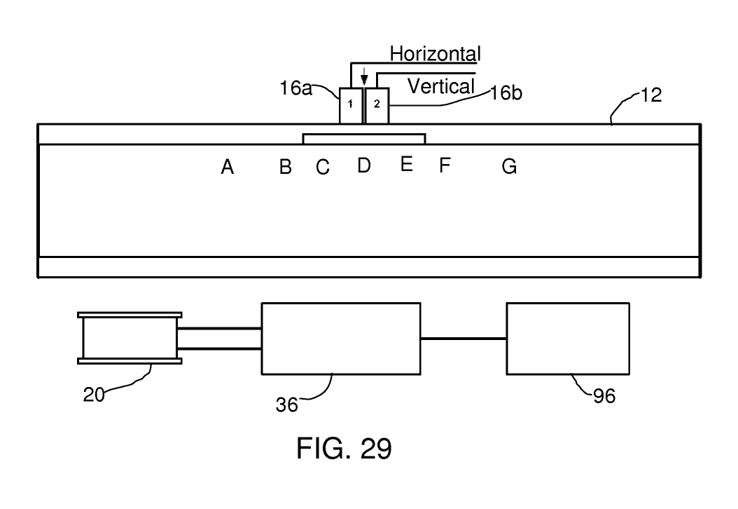

Differential Phase Measurements—In search of a better measurement method that would improve the visibility in locating internal defects, we have discovered that by taking differential phase measurements, the resolution is significantly enhanced over the relative phase method. Furthermore, a consistent pattern of phase shift over the defect region was observed, independent on the size of the defect. FIG. 29 shows a diagram giving the location of probe portion 11 and exciter coils 20 on a pipe 12. An oscillator block 96 is used to represent the input signal that is amplified by amplifier block 36. In this situation, probe portion 11 is represented by two detectors 16a and 16b, which are used to obtain differential phase measurements. The pair of adjacent detectors 16a and 16b are placed at positions A, B, C, D, and E. The vertical arrow shows the center of the pair of detectors 16a and 16b.

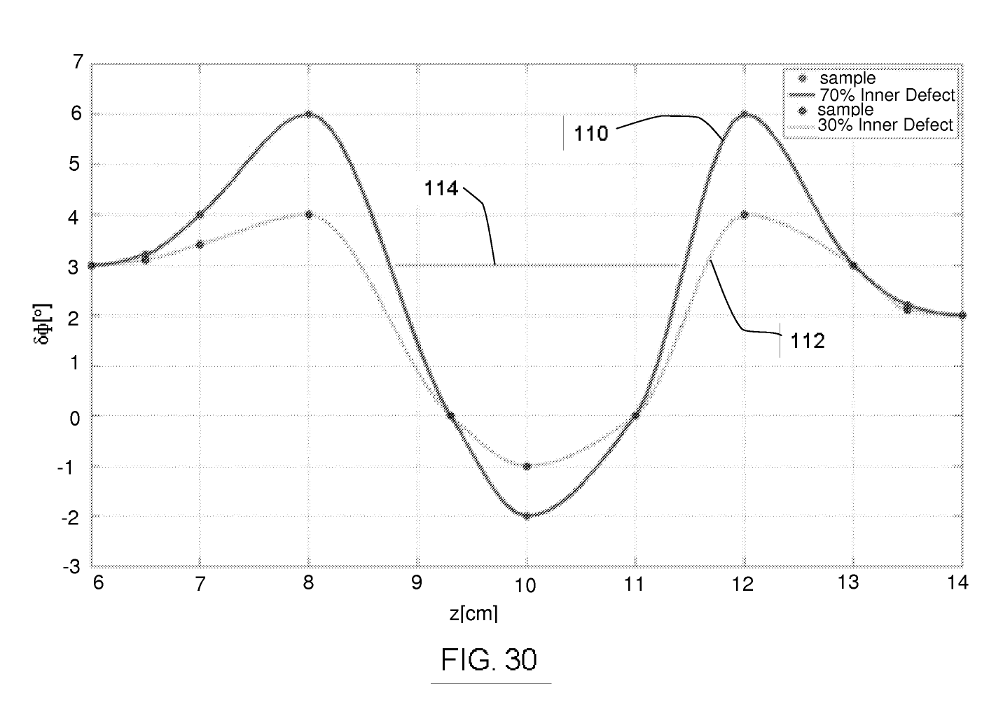

Since differences are taken between detectors 16a and 16b, calibration of the instrument was not required. The benefit of using the differential phase measurement method was first discovered through observations. Over regions of known good pipe, a constant phase difference of approximately 2° was measured, which is shown in FIG. 30. As detectors 16a and 16b approach the periphery of the defect, there is a sharp increase to 6° . Approximately ⅓ of the way into the defect region a null in phase is approached. At the center of the defect region there is a slight phase reversal of approximately 1°. FIG. 30 is a graph showing differential phase versus axial distance on a pipe. The graph shows measurements of 70% (line 110) and 30% (line 112) inner defects with 26 mm diameter. The center line 114 shows the location of the defect in relation to phase differences. Line 114 on the graph shows the location of the defect with respect to data measurements taken.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A blanket probe for detecting the thickness of a wall having a non-planar surface, the blanket probe comprising:
a probe portion comprising a planar substrate that is flexible in one or two dimensions;
an array of detectors mounted on the substrate; and
at least one interface for communicating signals to and from each detector.

2. The blanket probe of claim 1, wherein the substrate is a flexible printed circuit board.

3. The blanket probe of claim 1, wherein the array of detectors is a two dimensional array of detector coils.

4. The blanket probe of claim 1, wherein the array of detectors is sensitive to an electromagnetic field having mutually orthogonal directions.

5. The blanket probe of claim 1, wherein the wall is the wall of a pipe, tank or vessel.

6. The blanket probe of claim 5, wherein the wall is made from at least one of carbon steel, copper, brass, cupro-nickel, and ferritic.

7. The blanket probe of claim 1, wherein the planar substrate comprises one or more stiffeners to reduce flexibility in one dimension.

8. The blanket probe of claim 1, wherein one or more multiplexers connect the array of detectors to the at least one interface to serially record a detection signal.

9. The blanket probe of claim 1, further comprising at least one exciter for exciting the wall.

10. The blanket probe of claim 9, wherein the at least one exciter generates an electromagnetic field.

11. The blanket probe of claim 10, further comprising an operator unit for inputting instructions and displaying test results, an interface unit comprising the at least one interface for receiving detection signals from the detectors and sending control signals to the exciter unit, and an exciter unit for controlling the at least one exciter.

12. The blanket probe of claim 11, wherein the operator unit, the interface unit and the exciter unit communicate by wired or wireless links.

13. The blanket probe of claim 11, wherein at least the operator unit and the interface unit are housed within a portable housing.

14. The blanket probe of claim 9, wherein the wall is a pipe wall and the at least one exciter is positioned on an opposite side of the pipe from the probe portion.

15. The blanket probe of claim 9, wherein the wall is a pipe wall and the at least one exciter is positioned inside the pipe.

16. The blanket probe of claim 9, wherein the wall is a pipe wall and the at least one exciter is positioned adjacent to the probe portion.

17. A method of testing a non-planar wall having a finite thickness, comprising the steps of:
positioning a planar substrate that is flexible in one or two dimensions on the non-planar wall, the planar substrate having an array of detectors;
exciting the non-planar wall;
measuring detected signals generated by the array of detectors;
generating an output that characterizes the non-planar wall.

18. The method of claim 17, wherein the planar substrate is a flexible printed circuit board and the array of detectors is a two dimensional array of detector coils.

19. The method of claim 17, wherein measuring detected signals comprises measuring mutually orthogonal components of an electromagnetic field.

20. The method of claim 17, wherein the non-planar wall is made from at least one of carbon steel, copper, brass, cupro-nickel, and ferritic.

21. The method of claim 17, wherein measuring detected signals comprises using multiplexers to serially record the detected signals.

22. The method of claim 17, further comprising the step of inputting instructions into an operator unit and transmitting the instructions to an interface unit, the interface unit measuring the detected signals and controlling an exciter that excites the non-planar wall.
